(19) United States
(12) Patent Application Publication
(10) Pub. No.: US 2024/0243801 A1
(43) Pub. Date: Jul. 18, 2024

(54) MULTI-FACETED SIGNAL AMPLIFICATION REPEATER, MULTI-LAYER STRUCTURE CABLE, AND COMMUNICATION SYSTEM INCLUDING REPEATERS AND CABLES

(71) Applicant: SEMES CO., LTD., Chungcheongnam-do (KR)

(72) Inventors: Jongsuk WON, Seongnam-si (KR); Hyeongjun CHO, Seoul (KR)

(21) Appl. No.: 18/408,681

(22) Filed: Jan. 10, 2024

(30) Foreign Application Priority Data
Jan. 12, 2023 (KR) 10-2023-0004931

(51) Int. Cl. H04B 7/155

(52) U.S. Cl. CPC H04B 7/15507; H04B 7/15535

(57) ABSTRACT

The present invention provides a multi-faceted signal amplification repeater including N (N is an integer of 3 or more) repeater modules surrounding a cable for signal transmission between a transmitting end and a receiving end; and N connect pins connecting the N repeater modules to each other, wherein among the N repeater modules, M (M is an integer greater than or equal to 1 but less than N) repeater modules are repeater units that amplify a signal transmitted through the cable, and among the N repeater modules, L (L is an integer equal to N−M) power units are power units that supply power for an operation of the repeater units.

### CROSS-REFERENCE TO RELATED APPLICATION

This application is based on and claims priority under 35 U.S.C. § 119 to Korean Patent Application No. 10-2023-0004931, filed on Jan. 12, 2023, in the Korean Intellectual Property Office, the disclosure of which is incorporated by reference herein in its entirety.

### BACKGROUND

### 1. Field

The present invention relates to a multi-faceted signal amplification repeater, a multi-layer structure cable, and a communication system including repeaters and cables that may be used for long-distance communications.

### 2. Description of the Related Art

Generally, for communication between a transmitting end and a receiving end, a cable is required to connect the transmitting end to the receiving end. Conventionally, flat cables have been widely used to connect a transmitting end to a receiving end because the structure of flat cables is relatively simple and their manufacturing cost is low. When connecting a transmitting end to a receiving end, impedance matching, which makes the impedance of the cable the same as the impedance of the receiving end, is used as a method to reduce reflection loss due to the difference in impedance between the cable and the receiving end. When power passes between the transmitting end and the receiving end through the cable and the impedance is not matched between the cable and the receiving end, a power phase difference occurs. When the power phase difference occurs, a reflected wave is generated due to a delay in the transmission of power, thereby generating reflected power. The reflected power may be a factor that causes uneven power transmission. Accordingly, in order to minimize power loss for communication between a transmitting end and a receiving end and to transmit power between the transmitting end and the receiving end with maximum load, impedance matching between the cable and the receiving end may be used.

When the distance between the transmitting end and the receiving end becomes greater than a preset distance, a repeater may be used to amplify a communication signal between the transmitting end and the receiving end. The repeater is a device that receives a signal on an electromagnetic or optical transmission medium, amplifies the received signal, and retransmits the signal to the next section of the medium. Repeaters are widely used in communication networks because they overcome signal attenuation due to electromagnetic field diffusion or cable loss.

### SUMMARY

Conventional flat cables do not include an external shield and are not impedance matched. Accordingly, reflection loss of communication signals may occur, which may cause interference with heater signals, power signals, etc. placed within the cable, resulting in communication errors. In particular, in various communication environments, the distance between the transmitting end and the receiving end may increase, and in this case, the length of the cable has no choice but to become longer. Accordingly, the possibility of communication errors occurring may further increase.

Embodiments provide a multi-faceted signal amplification repeater, a multi-layer structured cable, and a communication system including a repeater and a cable that overcomes signal attenuation in long-distance communication and reduces the possibility of communication errors to ensure stable communication.

The problems to be solved through the embodiments are not limited to the above-mentioned problems, and problems not mentioned may be clearly understood by those skilled in the art from this specification and the attached drawings.

Additional aspects will be set forth in part in the description which follows and, in part, will be apparent from the description, or may be learned by practice of the presented embodiments of the disclosure.

The technical idea of the present invention to solve the above-described problems provides a multi-faceted signal amplification repeater including N (N is an integer of 3 or more) repeater modules surrounding a cable for signal transmission between a transmitting end and a receiving end; and N connect pins connecting the N repeater modules to each other, wherein among the N repeater modules, M (M is an integer greater than or equal to 1 but less than N) repeater modules are repeater units that amplify a signal transmitted through the cable, and among the N repeater modules, L (L is an integer equal to N−M) power units are power units that supply power for an operation of the repeater units.

In one embodiment of the present invention, the multi-faceted signal amplification repeater further includes a connector connecting at least one of the M repeater units and a communication line disposed in the cable to each other.

In one embodiment of the present invention, a power line disposed within the cable may pass through the N repeater modules without being connected to the connector.

In one embodiment of the present invention, an insertion hole is formed by the N repeater modules arranged to surround the cable, and the cable may be inserted into the insertion hole.

In one embodiment of the present invention, the power unit may supply power to the repeater unit using power used in the transmitting end or the receiving end.

In one embodiment of the present invention, the power unit may supply power to the repeater unit through the connect pin.

In one embodiment of the present invention, at least one of the N repeater modules may include a terminating resistance having a resistance matched to the impedance of the cable.

In one embodiment of the present invention, a size of the repeater unit may be greater than a size of the power unit.

In one embodiment of the present invention, M may be greater than or equal to L.

In one embodiment of the present invention, when N is 4 or more and M is 2 or more, one of the M repeater units may be arranged to face another one of the M repeater units.

In one embodiment of the present invention, when N is 3 or more and L is 1 or more, L power units are arranged so that the repeater units are located on both sides of the L power units.

In one embodiment of the present invention, a distance between the repeater unit and the cable is less than a distance between the power unit and the cable.

In addition, the technical idea of the present invention provides a multi-layer structure cable including a power line transmitting power signals between a transmitting end and a receiving end; a communication line disposed outside the power line and transmitting a communication signal between the transmitting end and the receiving end; and a first shield disposed between the communication line and the power line to shield signals against interference between the power line and the communication line and for impedance matching with the receiving end.

In one embodiment of the present invention, the power line includes a first power line that transmits a direct current (DC) signal and a second power line that is disposed inside the first power line and transmits an alternating current (AC) signal.

In one embodiment of the present invention, the multi-layer structure cable may further include an inter-power shield disposed between the first power line and the second power line to shield signals against interference between the first power line and the second power line.

In one embodiment of the present invention, a distance between the first shield and the communication line is less than a distance between the first shield and the power line.

In one embodiment of the present invention, the multi-layer structure cable may further include a second shield disposed outside the communication line.

In addition, the technical idea of the present invention provides a communication system including a multi-layer structure cable including a power line that transmits a power signal between a transmitting end and a receiving end, a communication line disposed outside the power line and transmitting a communication signal between the transmitting end and the receiving end, and a first shield disposed between the communication line and the power line to shield signals against interference between the power line and the communication line and for impedance matching with the receiving end; and a multi-faceted signal amplification repeater having N repeater modules surrounding the multi-layer structure cable (N is an integer of 3 or more) and N connect pins connecting the N repeater modules to each other.

In one embodiment of the present invention, among the N repeater modules, M (M is an integer greater than or equal to 1 but less than N) repeater units are repeater units that amplify a signal transmitted through the cable, and among the N repeater modules, L (L is an integer equal to N−M) power units are power units that supply power for an operation of the repeater units.

In one embodiment of the present invention, the multi-faceted signal amplification repeater may further include a connector connecting at least one of the M repeater units to a communication line disposed within the multi-layer structure cable

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing a communication system according to the prior art.

FIG. 2 is a block diagram of a communication system including a multi-faceted signal amplification repeater according to an embodiment and a multi-layer structure cable according to an embodiment.

FIG. 3 is a schematic perspective view of a multi-faceted signal amplification repeater according to an embodiment and a multi-layer structure cable according to an embodiment.

FIG. 4 is a cross-sectional view of a multi-faceted signal amplification repeater according to an embodiment and a multi-layer structure cable according to an embodiment based on a section line IV-IV of FIG. 3.

FIG. 5 is a cross-sectional view illustrating a multi-faceted signal amplification repeater according to an embodiment.

FIG. 6 is a cross-sectional view showing an example of a multi-faceted signal amplification repeater according to an embodiment including three repeater modules.

FIGS. 7 to 10 are cross-sectional views showing examples of a multi-faceted signal amplification repeater according to an embodiment including four repeater modules.

FIG. 11 is a cross-sectional view showing an example of a multi-faceted signal amplification repeater according to an embodiment including five repeater modules.

FIG. 12 is a cross-sectional view showing an example of a multi-faceted signal amplification repeater according to an embodiment including six repeater modules.

FIG. 13 is a cross-sectional view showing an example of a multi-layer structure cable according to an embodiment having a two-layer structure.

FIG. 14 is a cross-sectional view showing an example of a multi-layer structure cable according to an embodiment having a three-layer structure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As for the terms used in the embodiments, currently widely used general terms were selected as much as possible while considering the functions in the present invention, but this may vary depending on the intentions or precedents of engineers working in the field, the emergence of new technologies, etc. In addition, in certain cases, there are terms arbitrarily selected by the applicant, and in this case, the meaning will be described in detail in the description of the relevant invention. Therefore, the terms used in the present invention should be defined based on the meaning of the term and the overall description of the present invention, rather than simply the name of the term.

When it is said that a portion “includes” a certain element throughout the specification, this means that, unless specifically stated to the contrary, it does not exclude other elements but may further include other elements. In addition, terms such as “ . . . unit” and “ . . . module” used in the specification refer to a unit that processes at least one function or operation, which may be implemented as hardware or software, or as a combination of hardware and software.

In the following description, when a component is described as being connected to another component, it may be directly connected to the other component, but a third component may be therebetween. Similarly, when a component is described as being disposed on top of another component, it may be disposed directly on top of other component, or a third component may be therebetween. In addition, the structure or size of each component in the drawings may be exaggerated for convenience and clarity of explanation, and parts unrelated to the explanation may be omitted.

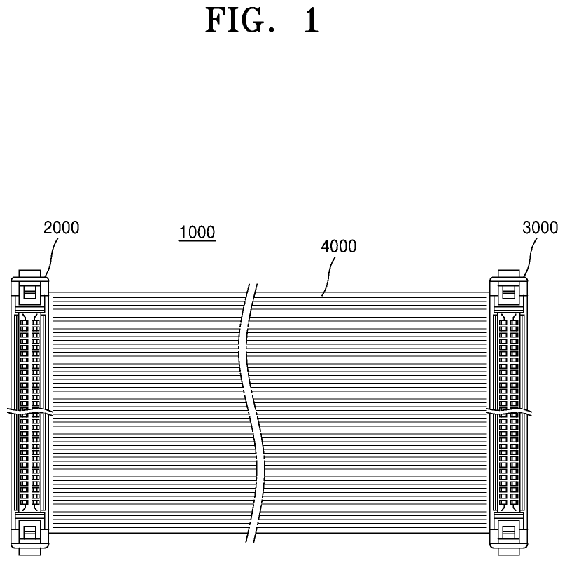

FIG. 1 is a diagram showing a communication system according to the prior art.

Referring to FIG. 1, a communication system 1000 according to the prior art includes a cable 4000 for communication between a transmitting end 2000 and a receiving end 3000. In the communication system 1000 according to the prior art, the cable 4000 has a flat shape and is widely used to connect the transmitting end 2000 to the receiving end 3000 because the structure thereof is relatively simple and the manufacturing cost thereof is low.

The conventional cable 4000 with flat shape does not include an external shield and is not impedance matched. Impedance matching refers to making the impedance of the cable 4000 and the receiving end 3000 the same to reduce reflection loss due to the difference in impedance between the cable 4000 and the receiving end 3000 when communication occurs between the transmitting end 2000 and the receiving end 3000.

When power passes between the transmitting end 2000 and the receiving end 3000 along the cable 4000, in a case where the impedance between the cable 4000 and the receiving end 3000 is not matched, a phase difference occurs in power. When the phase difference occurs, a reflected wave is generated due to a delay in the transmission of power, thereby generating reflected power. The reflected power may be a factor that causes unevenness of signal transmission.

Accordingly, according to the communication system 1000 according to the prior art, because the impedance between the cable 4000 and the receiving end 3000 is not matched, a reflection loss of the communication signal may occur, causing interference with the heater signal, power signal, etc. disposed in the cable 4000, resulting in a communication error. In particular, depending on the communication environment, the distance between the transmitting end 2000 and the receiving end 3000 may increase (for example, more than about 2 m). In this case, the length of the cable inevitably becomes longer, so the equipment of the communication system may become larger. Additionally, as the return loss of communication signals becomes larger, the possibility of communication errors may further increase. Therefore, the communication system 1 according to the prior art had a design limitation in that the distance between the transmitting end 2000 and the receiving end 3000 was limited to less than a preset range (e.g., about 5 m).

The following embodiments relate to a multi-faceted signal amplification repeater, a multi-layer structure cable, and a communication system including the repeater and the cable that overcomes signal attenuation in long-distance communication and reduces the possibility of communication errors even in long-distance communication to ensure stable communication. Below, with reference to the attached drawings, embodiments of the present invention are described in detail so that those skilled in the art may easily practice them. However, the embodiments may be implemented in many different forms and are not limited to the embodiments described herein.

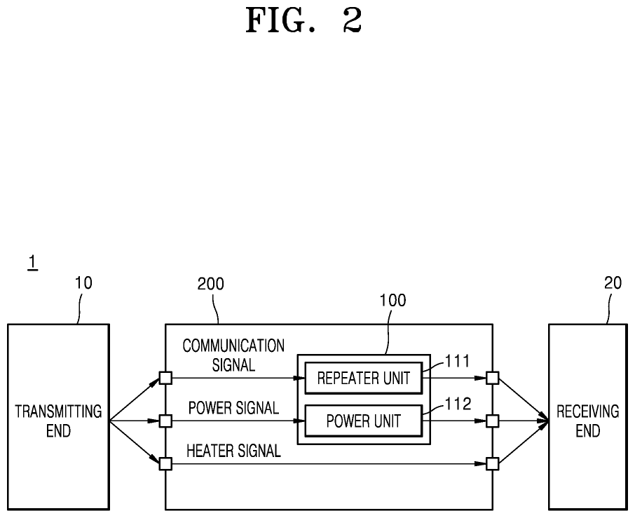

FIG. 2 is a block diagram of a communication system including a multi-faceted signal amplification repeater according to an embodiment and a multi-layer structure cable according to an embodiment.

Referring to FIG. 2, a communication system 1 according to the embodiment is used for signal transmission between a transmitting end 10 and a receiving end 20. The receiving end 20 may be an inkjet head and the transmitting end 10 may be a driver that transmits a communication signal such as a control command signal for operating the inkjet head, a power signal, and a heater signal.

The communication system 1 according to the embodiment includes a multi-faceted signal amplification repeater 100 according to the embodiment and a multi-layer structure cable 200 according to the embodiment. Hereinafter, the multi-faceted signal amplification repeater 100 according to the embodiment and the multi-layer structure cable 200 according to the embodiment are sequentially described.

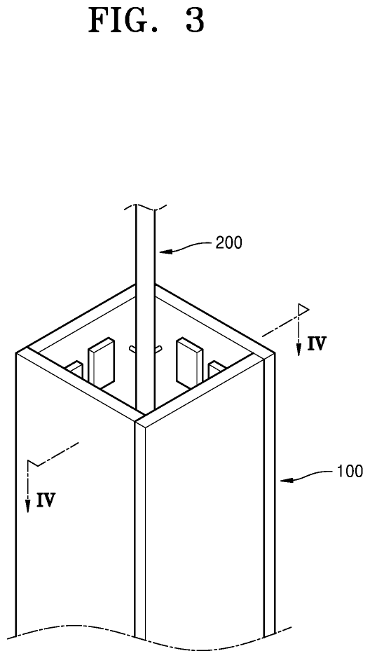

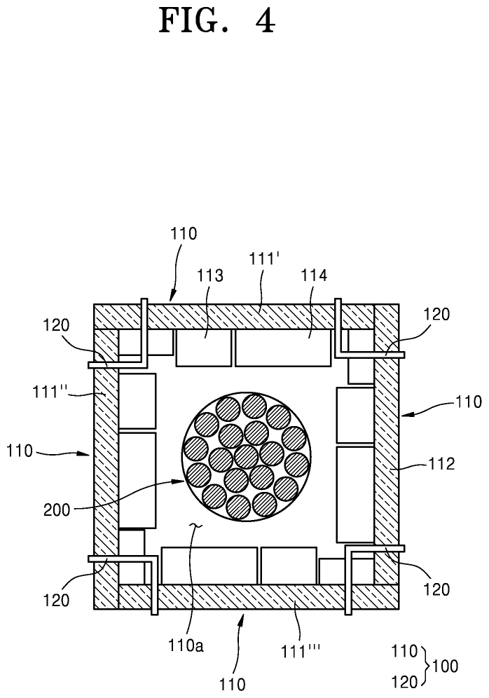

FIG. 3 is a schematic perspective view of a multi-faceted signal amplification repeater according to an embodiment and a multi-layer structure cable according to an embodiment, and FIG. 4 is a cross-sectional view of a multi-faceted signal amplification repeater according to an embodiment and a multi-layer structure cable according to an embodiment based on the section line IV-IV of FIG. 3.

Referring to FIGS. 3 and 4, the multi-faceted signal amplification repeater 100 according to the embodiment is arranged to surround the outside of the multi-layer structure cable 200 according to the embodiment. In the embodiment, the multi-faceted signal amplification repeater 100 and the multi-layer structure cable 200 may be integrated into one structure. The multi-faceted signal amplification repeater 100 according to the embodiment may amplify the strength of the signal transmitted by the multi-layered structured cable 200 according to the embodiment.

The multi-faceted signal amplification repeater 100 according to the embodiment includes a repeater module 110, a connect pin 120, and a connector. However, the components of the multi-faceted signal amplification repeater 100 according to the embodiment are not limited thereto, and components according to the embodiment may be added or at least one component may be omitted.

FIG. 4 shows four repeater modules 110 surrounding a multi-layer structure cable 200 according to the embodiment. One connect pin 120 may be connected to two repeater modules 110 respectively to secure the two repeater modules 110.

As the four repeater modules 110 are arranged to surround the outside of the cable 200, an insertion hole 110a may be formed inside the four repeater modules 110. The multi-layer structure cable 200 according to the embodiment may pass through the inside of the four repeater modules 110 while being inserted into the insertion hole 110a.

At least one of the four repeater modules 110 may be a repeater unit 111 (shown in FIG. 2) that amplifies the signal transmitted through the multi-layer structure cable 200 according to the embodiment.

In the embodiment, the repeater unit 111 may amplify communication signals among signals transmitted through the multi-layer structure cable 200 according to the embodiment. The repeater unit 111 may include a buffer space for amplifying a signal, a communication PCB, and a repeater integrated circuit (IC) circuit.

At least one of the four repeater modules 110 may be a power unit 112 that supplies power for the operation of the repeater unit 111.

The power unit 112 may directly supply power to an adjacent repeater unit 111, and may also supply power to another repeater unit 111 through an adjacent repeater unit 111. In the embodiment shown in FIG. 4, the power unit 112 may supply power to the adjacent repeater unit 111′ and/or the facing repeater unit 111″ through the repeater unit 111″. In one example, the power supplied by the power unit 112 may be 3.3 V. The power unit 112 may include a voltage conversion PCB.

The power unit 112 may supply power to the repeater unit 111 using the power used in the transmitting end 10 or the receiving end 20. In order to supply the power, the multi-faceted signal amplification repeater 100 according to the embodiment may include a wire connecting the power unit 112 to the transmitting end 10 or the receiving end 20. That is, the multi-faceted signal amplification repeater 100 according to the embodiment may operate the repeater unit 111 by converting the voltage used at the transmitting end 10 or the receiving end 20 through the power unit 112 even without applying a separate power source from the outside. Therefore, according to the multi-faceted signal amplification repeater 100 according to the embodiment, compared to the comparative example in which a separate power is applied from the outside, the equipment cost for operating the repeater unit 111 may be reduced.

The power unit may supply power to the repeater unit 111 through the connect pin 120. This is because the connect pin 120 is coupled between the repeater modules 110. The power unit 112 may supply power by flowing operating current to the repeater unit 111 through the connect pin 120. The connect pin 120 may include a metal material.

FIG. 4 shows an embodiment in which among four repeater modules 110, three are repeater units 111 and one is a power unit 112, but this is an example and various combinations may be possible. That is, based on the example shown in FIG. 4, two of the four repeater modules 110 may be repeater units 111 and two may be power units 112 depending on the communication environment.

At least one of the four repeater modules 110 may include a terminating resistor 113 having a resistance matched to the impedance of the multi-layer structure cable 200 according to the embodiment. The termination resistance 113 may attenuate reflected waves generated as signals are transmitted through the multi-layer structure cable 200 according to the embodiment. The termination resistance 113 allows a current of a preset size to flow through the multi-layer structure cable according to the embodiment, thereby matching the impedance of the multi-layer structure cable 200 according to the embodiment with the impedance of the receiving end 20.

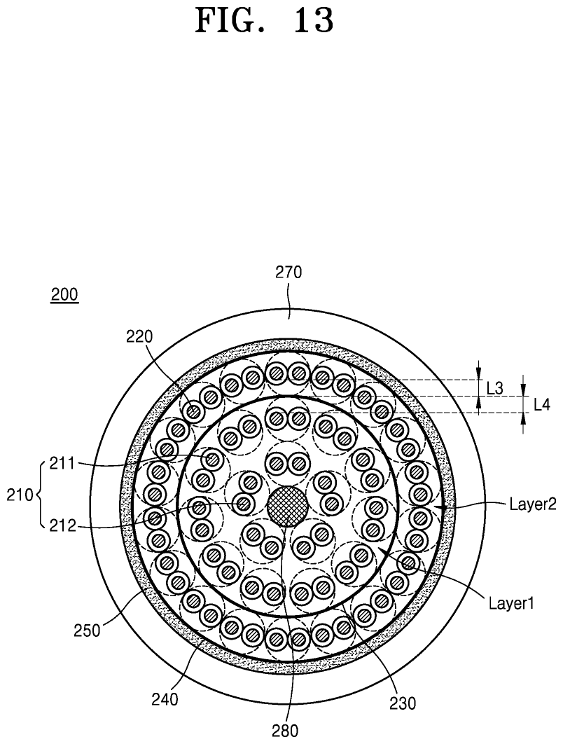

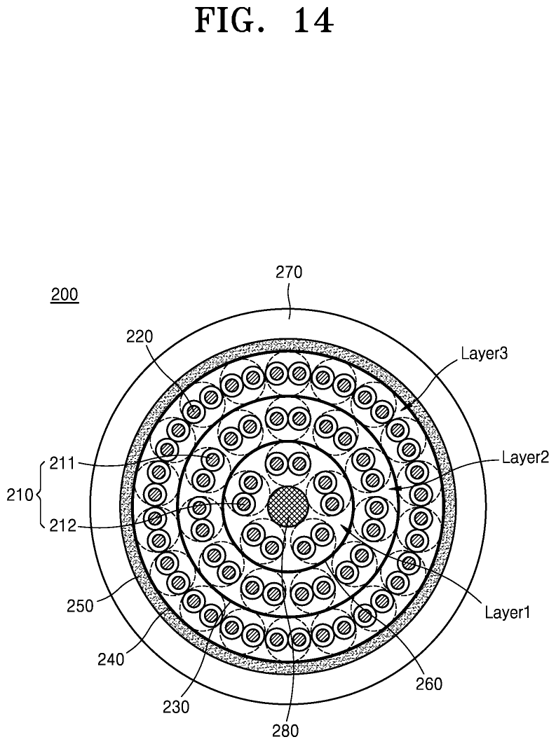

At least one of the four repeater modules 110 may include a repeater pillar 114 disposed on the PCB. The repeater filler 114 may serve as a low-power retransmission station that receives and retransmits communication signals transmitted by a communication line 220 (shown in FIG. 13 and FIG. 14).

Although not shown, the multi-faceted signal amplification repeater 100 according to the embodiment may further include a connector.

The connector connects lines arranged within the repeater unit 111 and the multi-layer structure cable 200 according to the embodiment to each other. In an embodiment, the connector may connect the communication line 220 disposed on the outermost side among the lines within the repeater unit 111 to the multi-layer structure cable 200. Because the communication line 220 is directly connected to the repeater unit 111 through a connector, the communication signal may be efficiently amplified and transmitted to the receiving end 20. As an example, the repeater unit 111 and communication line 220 may be directly connected to each other by soldering.

Here, the power signal transmitted by the power line 210 disposed in the multi-layer structure cable 200 according to the embodiment does not need to be connected to a repeater unit 111 due to characteristics of the power signal. Accordingly, the power line 210 may pass inside the multi-faceted signal amplification repeater 100 according to the embodiment without being connected to the connector.

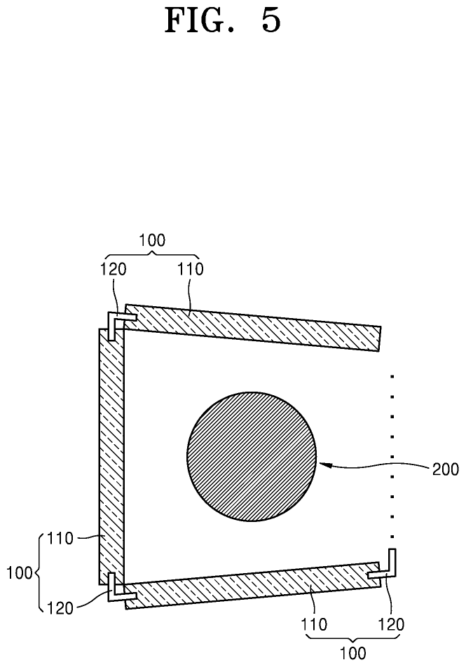

FIG. 5 is a cross-sectional view illustrating a multi-faceted signal amplification repeater according to an embodiment.

Referring to FIG. 5, a multi-faceted signal amplification repeater 100 according to the embodiment includes N repeater modules (N is an integer of 3 or more) surrounding a multi-layer structure cable 200 according to the embodiment, and N connect pins connecting the N repeater modules. That is, the multi-faceted signal amplification repeater 100 according to the embodiment may include three or more repeater modules 110 and three or more connect pins 120.

In this case, among N repeater modules, M (M is an integer greater than or equal to 1 but less than N) are repeater units, and among N repeater modules, L (L is an integer equal to N−M) are power units. That is, the sum of the number of repeater units 111 and the number of power units 112 is equal to the number of repeater modules 110.

Below, the multi-faceted signal amplification repeater 100 according to the embodiment is described in the case of N=3, 4, 5, and 6.

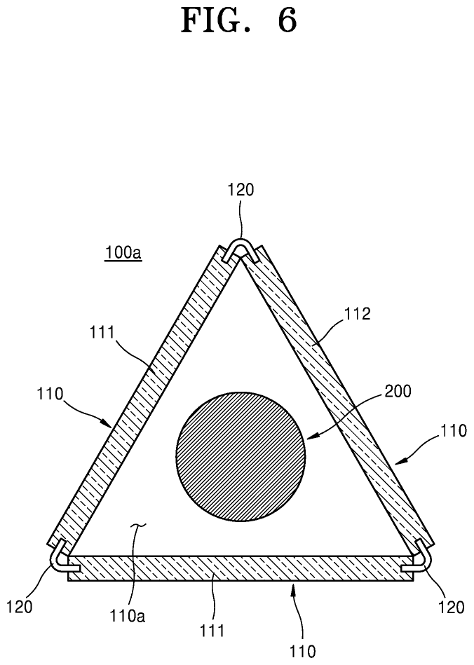

FIG. 6 is a cross-sectional view showing an example of a multi-faceted signal amplification repeater according to an embodiment including three repeater modules.

Referring to FIG. 6, a multi-faceted signal amplification repeater 100a according to an embodiment may include three repeater modules 110 and three connect pins 120 surrounding a multi-layer structure cable 200 according to an embodiment.

As the three repeater modules 110 are arranged to surround the outside of the cable 200, an insertion hole 110a may be formed inside the three repeater modules 110. The multi-layer structure cable 200 according to the embodiment may pass through the inside of the three repeater modules 110 while being inserted into the insertion hole 110a. In this case, the communication line 220 may be connected to the repeater unit 111 through a connector, and the power line 210 may pass through the insertion hole 110a without being connected to the repeater unit 111.

Because the repeater unit 111 and power unit 112 shown in FIG. 6 are the same as those described in FIG. 4, detailed descriptions thereof are omitted.

Although not shown in FIG. 6, the multi-faceted structure signal amplification repeater 100a according to the embodiment may include a termination resistance 113, a repeater filler 114, and a connector. In the multi-faceted signal amplification repeater 100a according to the embodiment, the terminating resistance 113, the repeater pillar 114, and the connector are the same as those described in FIG. 4, so detailed descriptions thereof are omitted.

FIG. 6 shows an embodiment in which among three repeater modules 110, two are repeater units 111 and one is a power unit 112, but this is an example and various combinations may be possible. Based on the example shown in FIG. 6, among three repeater modules 110, one may be a repeater unit 111 and two may be power units 112.

Referring to FIG. 6, M may be greater than L. That is, the multi-faceted signal amplification repeater 100a according to the embodiment may include a greater number of repeater units 111 than the number of power units 112. Therefore, the multi-faceted signal amplification repeater 100a according to the embodiment has the advantage of being usable even in communication environments that require a large number of communication lines 220 or a large amount of signal amplification.

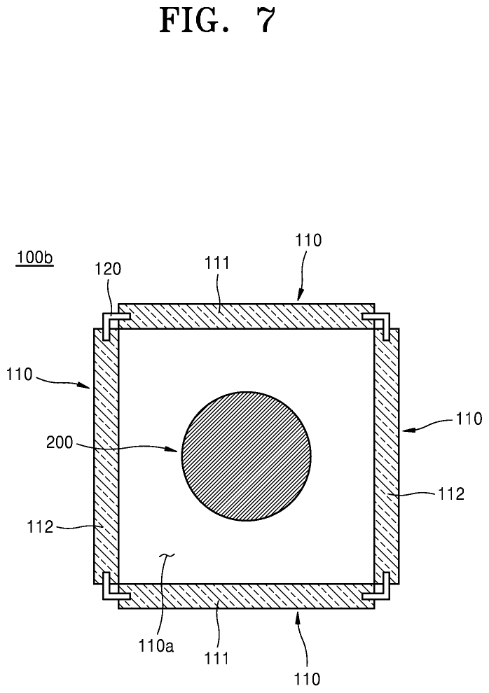

FIGS. 7 to 10 are cross-sectional views showing examples of a multi-faceted signal amplification repeater according to an embodiment including four repeater modules.

Referring to FIGS. 7 to 10, the multi-faceted signal amplification repeater 100b, 100c, 100d, and 100e according to the embodiment may include four repeater modules 110 and four connect pins 120 surrounding the multi-layer structure cable 200 according to the embodiment.

As the four repeater modules 110 are arranged to surround the outside of the cable 200, an insertion hole 110a may be formed inside the four repeater modules 110. The multi-layer structure cable 200 according to the embodiment may pass through the inside of the four repeater modules 110 while being inserted into the insertion hole 110a. In this case, the communication line 220 may be connected to the repeater unit 111 through a connector, and the power line 210 may pass through the insertion hole 110a without being connected to the repeater unit 111.

Because the repeater unit 111 and power unit 112 shown in FIGS. 7 to 10 are the same as those described in FIG. 4, detailed descriptions thereof are omitted.

Although not shown in FIGS. 7 to 10, the multi-faceted signal amplification repeaters 100b, 100c, 100d, and 100e according to the embodiment may include a termination resistance 113, a repeater pillar 114, and a connector. In the multi-faceted signal amplification repeater 100b, 100c, 100d, and 100e according to the embodiment, the terminating resistance 113, the repeater pillar 114, and the connector are the same as those described in FIG. 4, so detailed descriptions thereof are omitted.

Referring to FIG. 7, the two repeater units 111 may be arranged to face each other. Additionally, the two power units 112 may be arranged to face each other. Accordingly, according to the multi-faceted structure signal amplifying repeater 100b according to the embodiment, because one power unit 112 may supply power to repeater units 111 on both sides, a stable power supply may be achieved. In addition, because a connector may be placed on two opposing repeater units 111, the communication lines 220 arranged along the circumferential direction of the multi-layer structure cable 200 according to the embodiment may be evenly connected to the repeater units 111 without interfering with each other. Therefore, there is an advantage in securing space for placing the connector in the repeater module 110.

Referring to FIG. 7, M may be greater than or equal to L. That is, the multi-faceted signal amplification repeater 100b according to the embodiment may include a number of repeater units 111 equal to or greater than the number of power units 112. Therefore, the multi-faceted signal amplification repeater 100b according to the embodiment has the advantage of being usable even in communication environments that require a large number of communication lines 220 or a large amount of signal amplification.

FIG. 7 shows an embodiment in which among four repeater modules 110, two are repeater units 111 and two are power units 112, but this is an example and various combinations may be possible.

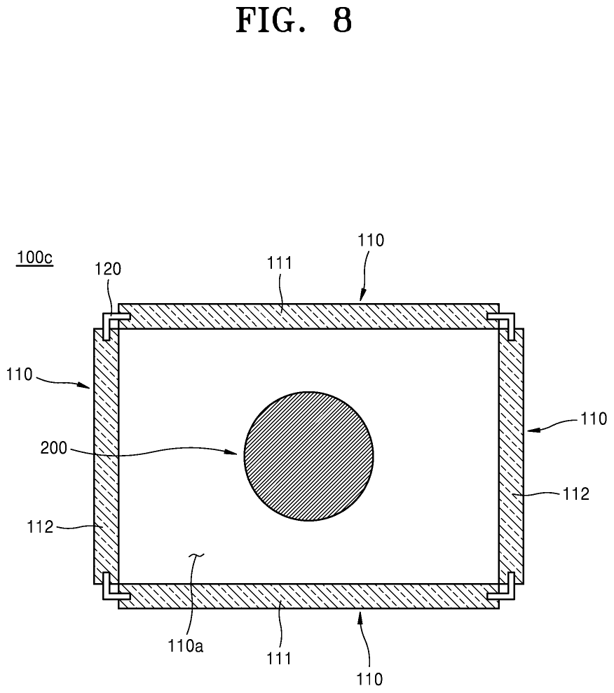

Referring to FIG. 8, the size of the repeater unit 111 may be greater than the size of the power unit 112. Accordingly, the multi-faceted signal amplification repeater 100c according to the embodiment may secure a sufficient area for the connector to be coupled to the repeater unit 111. Therefore, even in communication environments that requires a large number of communication lines or a large amount of signal amplification, the multi-faceted signal amplification repeater 100c according to the embodiment may be used, and thus responsiveness to various usage environments may be improved.

Even in the embodiment shown in FIG. 8, the two repeater units 111 may be arranged to face each other, and the two power units 112 may be arranged to face each other. In addition, in the embodiment shown in FIG. 8, M may be greater than or equal to L. That is, a multi-faceted signal amplification repeater 100c according to the embodiment may include a number of repeater units 111 equal to or greater than the number of power units 112.

FIG. 8 shows an embodiment in which among four repeater modules 110, two are repeater units 111 and two are power units 112, but this is an example and various combinations may be possible.

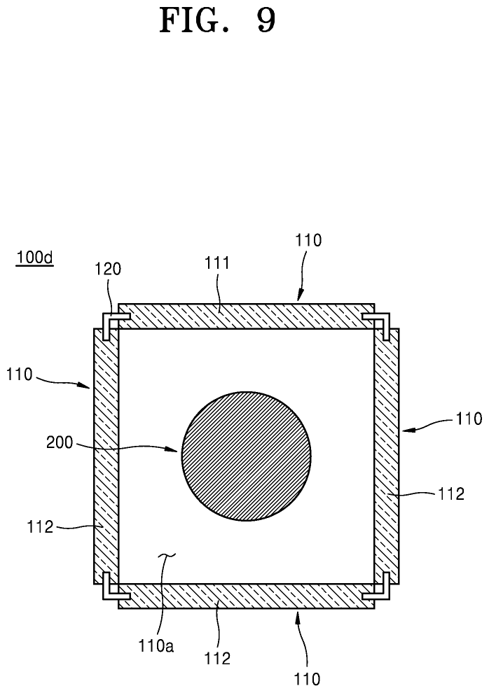

Referring to FIG. 9, a multi-faceted signal amplification repeater 100d according to the embodiment may include a number of repeater units 111 greater than the number of power units 112. Accordingly, the multi-faceted signal amplification repeater 100d according to the embodiment has the advantage of securing sufficient power usage even when the multi-faceted signal amplification repeater 100d includes a repeater unit 111 that consumes a lot of power.

FIG. 9 shows an embodiment in which among four repeater modules 110, one is repeater unit 111 and three are power units 112, but this is an example and various combinations may be possible.

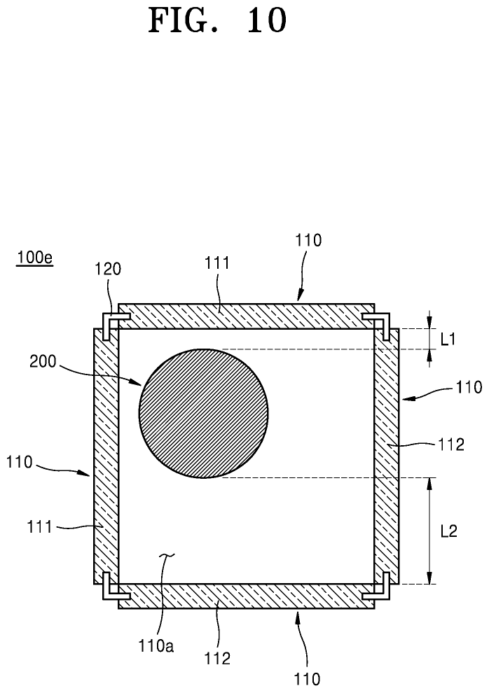

Referring to FIG. 10, the distance L1 between the repeater unit 111 and the cable 200 may be shorter than the distance L2 between the power unit 112 and the cable 200. That is, in the multi-faceted signal amplification repeater 100e according to the embodiment, the cable 200 may be placed close to the repeater unit 111 while inserted into the insertion hole 110a. Accordingly, the multi-faceted signal amplification repeater 100e according to the embodiment may be implemented in a structure in which the length of the connector connecting the repeater unit 111 to the communication line is short.

In addition, in the embodiment shown in FIG. 10, M may be greater than or equal to L. That is, a multi-faceted signal amplification repeater 100e according to the embodiment may include a number of repeater units 111 equal to or greater than the number of power units 112.

Referring to FIG. 10, the two repeater units 111 may be placed adjacent to each other and directly connected to each other through the connect pin 120 and the two power units 112 may be placed adjacent to each other and directly connected to each other through the connect pin 120.

FIG. 10 shows an embodiment in which among four repeater modules 110, two are repeater units 111 and two are power units 112, but this is an example and various combinations may be possible.

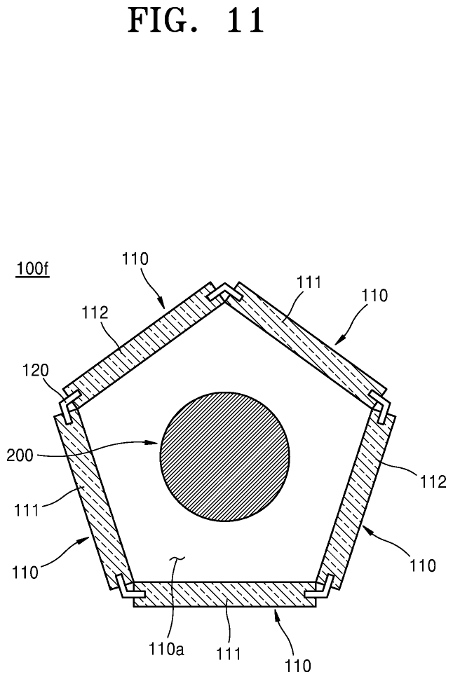

FIG. 11 is a cross-sectional view showing an example of a multi-faceted signal amplification repeater according to an embodiment including five repeater modules.

Referring to FIG. 11, the multi-faceted signal amplification repeater 100f according to the embodiment may include five repeater modules 110 and five connect pins 120 surrounding the multi-layer structure cable 200 according to the embodiment.

As the five repeater modules 110 are arranged to surround the outside of the cable 200, an insertion hole 110a may be formed inside the five repeater modules 110. The multi-layer structure cable 200 according to the embodiment may pass through the inside of the five repeater modules 110 while being inserted into the insertion hole 110a. In this case, the communication line 220 may be connected to the repeater unit 111 through a connector, and the power line 210 may pass through the insertion hole 110a without being connected to the repeater unit 111.

Because the repeater unit 111 and power unit 112 shown in FIG. 11 are the same as those described in FIG. 4, detailed descriptions thereof are omitted.

Although not shown in FIG. 11, the multi-faceted structure signal amplification repeater 100f according to the embodiment may include a termination resistance 113, a repeater filler 114, and a connector. In the multi-faceted signal amplification repeater 100f according to the embodiment, the terminating resistance 113, the repeater pillar 114, and the connector are the same as those described in FIG. 4, so detailed descriptions thereof are omitted.

Referring to FIG. 11, the two repeater units 111 may be arranged to face each other. Additionally, the two power units 112 may be arranged to face each other. Accordingly, according to the multi-faceted structure signal amplifying repeater 100f according to the embodiment, because one power unit 112 may supply power to repeater units 111 on both sides, a stable power supply may be achieved. In addition, the communication lines 220 arranged along the circumferential direction of the multi-layer structure cable 200 according to the embodiment may be evenly connected to the repeater units 111 without interfering with each other. Therefore, there is an advantage in securing space for placing the connector in the repeater module 110.

Referring to FIG. 11, M may be greater than L. That is, the multi-faceted signal amplification repeater 100f according to the embodiment may include a greater number of repeater units 111 than the number of power units 112. Therefore, the multi-faceted signal amplification repeater 100f according to the embodiment has the advantage of being usable even in communication environments that require a large number of communication lines 220 or a large amount of signal amplification.

Although not shown, the multi-faceted signal amplification repeater 100f according to an embodiment may include a greater number of power units 112 than the number of repeater units 111. Accordingly, the multi-faceted signal amplification repeater 100f according to the embodiment has the advantage of securing sufficient power usage even when the multi-faceted signal amplification repeater 100f includes a repeater unit 111 that consumes a lot of power.

Although not shown, even in the embodiment shown in FIG. 11, the size of the repeater unit 111 may be greater than the size of the power unit 112. Accordingly, the multi-faceted signal amplification repeater 100f according to the embodiment may secure a large area for connecting the connector to the repeater unit 111. Therefore, even in communication environments that require a large number of communication lines 220 or a lot of signal amplification, the multi-faceted signal amplification repeater 100f may be used according to the embodiment, and thus responsiveness to various usage environments may be improved.

In addition, in the embodiment shown in FIG. 11, the distance between the repeater unit 111 and the cable 200 may be shorter than the distance between the power unit 112 and the cable 200. That is, in the multi-faceted signal amplification repeater 100f according to the embodiment, the cable 200 may be placed close to the repeater unit 111 while inserted into the insertion hole 110a. Accordingly, the multi-faceted signal amplification repeater 100f according to the embodiment may be implemented in a structure in which the length of the connector connecting the repeater unit 111 to the communication line is short.

FIG. 11 shows an embodiment in which among five repeater modules 110, three are repeater units 111 and two are power units 112, but this is an example and various combinations may be possible.

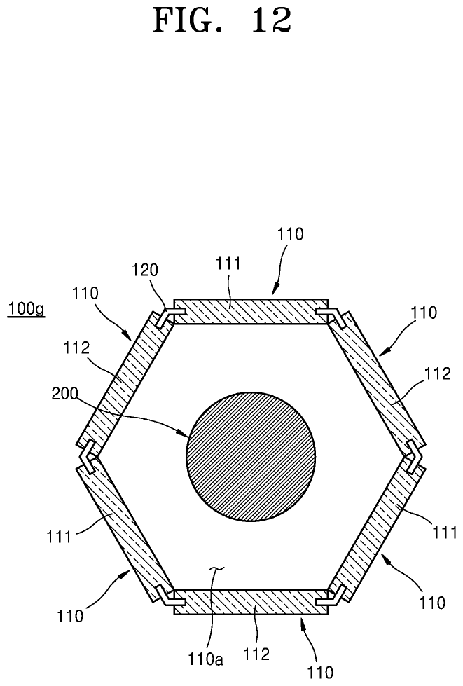

FIG. 12 is a cross-sectional view showing an example of a multi-faceted signal amplification repeater according to an embodiment including six repeater modules.

Referring to FIG. 12, a multi-faceted signal amplification repeater 100g according to the embodiment may include six repeater modules 110 and six connect pins 120 surrounding the multi-layer structure cable 200 according to the embodiment.

As the six repeater modules 110 are arranged to surround the outside of the cable 200, an insertion hole 110a may be formed inside the six repeater modules 110. The multi-layer structure cable 200 according to the embodiment may pass through the inside of the six repeater modules 110 while being inserted into the insertion hole 110a. In this case, the communication line 220 may be connected to the repeater unit 111 through a connector, and the power line 210 may pass through the insertion hole 110a without being connected to the repeater unit 111.

Because the repeater unit 111 and power unit 112 shown in FIG. 12 are the same as those described in FIG. 4, detailed descriptions thereof are omitted.

Although not shown in FIG. 12, the multi-faceted signal amplification repeater 100g according to the embodiment may include a termination resistance 113, a repeater filler 114, and a connector. In the multi-faceted signal amplification repeater 100g according to the embodiment, the terminating resistance 113, the repeater pillar 114, and the connector are the same as those described in FIG. 4, so detailed descriptions thereof are omitted.

Referring to FIG. 12, three repeater units 111 and three power units 112 may be arranged alternately with each other. Accordingly, according to the multi-faceted structure signal amplifying repeater 100g according to the embodiment, because one power unit 112 may supply power to repeater units 111 on both sides, a stable power supply may be achieved. In addition, the communication lines 220 arranged along the circumferential direction of the multi-layer structure cable 200 according to the embodiment may be evenly connected to opposite repeater units 111 without interfering with each other. Therefore, there is an advantage in securing space for placing the connector in the repeater module 110.

Referring to FIG. 12, M may be greater than or equal to L. That is, a multi-faceted signal amplification repeater 100g according to the embodiment may include a number of repeater units 111 equal to or greater than the number of power units 112. Therefore, the multi-faceted signal amplification repeater 100g according to the embodiment has the advantage of being usable even in communication environments that require a large number of communication lines 220 or a large amount of signal amplification.

Although not shown, the multi-faceted signal amplification repeater 100g according to the embodiment may include a greater number of power units 112 than the number of repeater units 111. Accordingly, the multi-faceted signal amplification repeater 100g according to the embodiment has the advantage of securing sufficient power usage even when the multi-faceted signal amplification repeater 100g includes a repeater unit 111 that consumes a lot of power.

Although not shown, even in the embodiment shown in FIG. 12, the size of the repeater unit 111 may be greater than the size of the power unit 112. Accordingly, the multi-faceted signal amplification repeater 100g according to the embodiment may secure a large area for connecting the connector to the repeater unit 111. Therefore, even in communication environments that require a large number of communication lines 220 or a lot of signal amplification, the multi-faceted signal amplification repeater 100g may be used according to the embodiment, and thus responsiveness to various usage environments may be improved.

In addition, in the embodiment shown in FIG. 12, the distance between the repeater unit 111 and the cable 200 may be shorter than the distance between the power unit 112 and the cable 200. That is, in the multi-faceted signal amplification repeater 100g according to the embodiment, the cable 200 may be placed close to the repeater unit 111 while inserted into the insertion hole 110a. Accordingly, the multi-faceted signal amplification repeater 100g according to the embodiment may be implemented in a structure in which the length of the connector connecting the repeater unit 111 to the communication line is short.

FIG. 12 shows an embodiment in which among six repeater modules 110, three are repeater units 111 and three are power units 112, but this is an example and various combinations may be possible.

Meanwhile, in the multi-faceted signal amplification repeater 100 according to the embodiment, as N increases, the size of the insertion hole 110a may increase, which is advantageous in securing space. Additionally, as N increases, more space may be secured to place a connector connecting the repeater unit 111 tod the communication line 220.

FIG. 13 is a cross-sectional view showing an example of a multi-layer structure cable according to an embodiment having a two-layer structure.

Referring to FIG. 13, the multi-layered cable 200 according to the embodiment includes a power line 210, a communication line 220, a first shield 230, a second shield 240, a third shield 250, an external insulator 270, and a cable pillar 280. However, the components of the multi-layer structure cable 200 according to the embodiment are not limited thereto, and components according to the embodiment may be added, or at least one component may be omitted.

The multi-layer structure cable 200 according to the embodiment connects the transmitting end 10 to the receiving end 20 to transmit communication signals, power signals, heater signals, etc. between the transmitting end 10 and the receiving end 20. The multi-layer structure cable 200 according to the embodiment is disposed inside the multi-faceted signal amplification repeater 100 according to the above-described embodiment and may transmit the signal amplified by the multi-faceted signal amplification repeater 100 according to the embodiment to the receiving end 20.

Generally, in order to achieve long-distance communication between a transmitting end 10 and a receiving end 20, a signal must be transmitted at maximum power from the transmitting end 10, and in order for the signal to be transmitted at maximum power, impedance matching between the cable 200 and the receiving end 20 is required. In an embodiment, based on the impedance of the receiving end 20 being about 50 ohm or about 70 ohm, the multi-layer structure cable 200 according to the embodiment may be designed to have an impedance of about 70 ohm.

According to an embodiment, the multi-layer structure cable 200 may be implemented as a structure having two layers. Hereinafter, an embodiment of a multi-layer structure cable 200 having a two-layer structure is described with reference to the attached FIG. 13.

The power line 210 transmits a power signal between the transmitting end 10 and the receiving end 20. The power signal transmitted by the power line 210 may be an alternating current (AC) signal or a direct current (DC) signal. The power line 210 may be located inside the communication line 220.

The power line 210 may include a first power line 211 and a second power line 212.

The first power line 211 may transmit a DC signal to the receiving end 20. The first power line 211 may be disposed between the communication line 220 and the second power line 212. A plurality of first power lines 211 may be arranged in the circumferential direction of the multi-layer structure cable 200. For example, there may be 22 first power lines 211 arranged. The first power line 211 may be arranged in pairs in the circumferential direction of the multi-layer structure cable 200. For example, when there are 22 first power lines 211, 11 pairs of first power lines 211 may be arranged in the circumferential direction of the multi-layer structure cable 200.

The second power line 212 may transmit an AC signal to the receiving end 20. The signal transmitted by the second power line 212 may be referred to as a heater signal and may be a signal of greater power than the signal transmitted by the first power line 211.

The second power line 212 may be disposed inside the first power line 211. Accordingly, the second power line 212 may be disposed on the innermost side of the multi-layer structure cable 200 according to the embodiment among the lines.

When the second power line 212 transmits a heater signal, which is a greater power signal than the signal transmitted by the first power line 211, to the receiving end 20, the heater signal may be more affected by noise generated from the communication signal transmitted by the communication line 220 than the first power line 211.

The multi-layer structure cable 200 according to the embodiment may be implemented in a structure where the second power line 212 is disposed on the innermost side of the multi-layer structure cable 200, thereby separating the second power line 212 from the communication line 220. Therefore, according to the multi-layer structure cable 200 according to the embodiment, the signal transmitted by the second power line 212 may be stably transmitted to the receiving end 20 with less influence of noise generated from the communication signal.

A plurality of second power lines 212 may be arranged in the circumferential direction of the multi-layer structure cable 200. For example, there may be 10 second power lines 212 arranged. The second power line 212 may be arranged in pairs in the circumferential direction of the multi-layer structure cable 200. For example, when there are 10 second power lines 212, 5 pairs of second power lines 212 may be arranged in the circumferential direction of the multi-layer structure cable 200.

In a modified embodiment, the second power line 212 may be disposed outside the first power line 211. That is, in a modified embodiment, the second power line 212 may be disposed between the communication line 220 and the first power line 211 and the first power line 211 may be disposed on the innermost side of the multi-layer structure cable 200.

The communication line 220 transmits communication signals between the transmitting end 10 and the receiving end 20. The communication signal transmitted by the communication line 220 may be a control command signal for operating the inkjet head. The communication line 220 may be located outside the power line 210. Accordingly, the multi-layer structure cable 200 according to the embodiment has a structure in which the connector may be easily coupled to the communication line 220.

A plurality of communication lines 220 may be arranged in the circumferential direction of the multi-layer structure cable 200. For example, there may be 36 communication lines 220 arranged. The communication lines 220 may be arranged in pairs in the circumferential direction of the multi-layer structure cable 200. For example, when there are 36 communication lines 220, 18 pairs of communication lines 220 may be arranged in the circumferential direction of the multi-layer structure cable 200.

The first shield 230 may be disposed between the communication line 220 and the power line 210. The first shield 230 may function to shield signal interference between signal interference between the communication line 220 and the power line 210 by shielding the electromagnetic field caused by the power line 210 and the electromagnetic field caused by the communication line 220. Accordingly, the lines 210 and 220 may stably transmit each signal to the receiving end 20.

In addition, the first shield 230 can reduce the return loss of a communication signal by lowering the characteristic impedance of the multi-layer structure cable 200 according to the embodiment. Accordingly, the multi-layer structure cable 200 according to the embodiment may be impedance matched with the receiving end 20.

The first shield 230 may be arranged in the circumferential direction of the communication line 220. The first shield 230 may extend in one direction along with the communication line 220 and the power line 210. The first shield 230 may include a metal material.

By using the first shield 230, the multi-layer cable 200 may be implemented as a structure having two layers. That is, as shown in FIG. 13, the multi-layer structure cable 200 according to the embodiment may include a first layer Layer 1 including the power line 210 disposed inside the first shield 230 and a second layer Layer 2 including the communication line 220 disposed outside the first shield 230.

The distance L3 between the first shield 230 and the communication line 220 may be shorter than the distance L4 between the first shield 230 and the power line 210. Here, the power line 210 may be the first power line 211. Accordingly, the communication line 220 may be placed closer to the first shield 230 than the first power line 211. As the communication line 220 is placed closer to the first shield 230, the impedance of the multi-layer structure cable 200 according to the embodiment may be lowered. Accordingly, the communication line 220 may have a uniform impedance in the direction in which the first shield extends, and thus the communication signal may be stably transmitted to the receiving end 20.

The second shield 240 is disposed outside the communication line 220. The second shield 240 may function to shield signals of the communication line 220 from being transmitted to the outside. That is, the second shield 240 may reduce the possibility of external electronic devices being affected by noise caused by communication signals by shielding the electromagnetic field caused by the communication line 220.

In addition, the second shield 240 may lower the characteristic impedance of the multi-layer structure cable 200 according to the embodiment, thereby lowering the return loss of the communication signal. Accordingly, the multi-layer structure cable 200 according to the embodiment may be impedance matched with the receiving end 20.

The second shield 240 may be arranged in the circumferential direction of the communication line 220. The second shield 240 may extend in one direction along with the communication line 220 and the power line 210. The second shield 240 may include a metal material.

The third shield 250 is disposed outside the second shield 240. The third shield 250, together with the second shield 240, may perform the function of shielding the signal of the communication line 220 from being transmitted to the outside. That is, the third shield 250 and the second shield 240 double shield the electromagnetic field caused by the communication line 220, thereby further reducing the possibility that external electronic devices will be affected by noise caused by communication signals.

In addition, the third shield 250 may reduce the return loss of communication signals by lowering the characteristic impedance of the multi-layer structure cable 200 according to the embodiment. Accordingly, the multi-layer structure cable 200 according to the embodiment may be impedance matched with the receiving end 20.

The third shield 250 may be arranged in the circumferential direction of the communication line 220. The third shield 250 may extend in one direction along with the communication line 220 and the power line 210. The third shield 240 may include a metal material.

The external insulator 270 may be disposed outside the third shield 250. The external insulator 270 may extend in one direction together with the third shield 250. The external insulator 270 may include an insulating rubber material.

The cable pillar 280 is disposed inside the second power line 212. The cable pillar 280 may extend in one direction along with the power line 210. The cable filler 280 may include polyvinyl chloride, non-halogen-based retardant thermoplastic resin, or polyethylene material.

FIG. 14 is a cross-sectional view showing an example of a multi-layer structure cable according to an embodiment having a three-layer structure.

According to an embodiment, a multi-layer structure cable 200 may be implemented as a structure having three layers. Hereinafter, an embodiment of the multi-layer structure cable 200 having a three-layer structure is described with reference to the attached FIG. 14. The multi-layer structure cable 200 having a three-layer structure may further include a inter-power shield 260 compared to the multi-layer structure cable 200 having a two-layer structure.

The power line 210 transmits a power signal between the transmitter 10 and the receiver 20. The power signal transmitted by the power line 210 may be an AC signal, a DC signal. The power line 210 may be located inside of the communication line 220.

The power line 210 may include a first power line 211 and a second power line 212.

The first power line 211 may transmit a DC signal to the receiving end 20. The first power line 211 may be disposed between the communication line 220 and the second power line 212. A plurality of first power lines 211 may be arranged in the circumferential direction of the multi-layer structure cable 200. For example, there may be 22 first power lines 211 arranged. The first power line 211 may be arranged in pairs in the circumferential direction of the multi-layer structure cable 200. For example, when there are 22 first power lines 211, 11 pairs of first power lines 211 may be arranged in the circumferential direction of the multi-layer structure cable 200.

The second power line 212 may transmit an AC signal to the receiving end 20. The signal transmitted by the second power line 212 may be referred to as a heater signal and may be a signal of greater power than the signal transmitted by the first power line 211.

The second power line 212 may be disposed inside the first power line 211. Accordingly, the second power line 212 may be disposed on the innermost side of the multi-layer structure cable 200 according to the embodiment among the lines.

When the second power line 212 transmits a heater signal, which is a greater power signal than the signal transmitted by the first power line 211, to the receiving end 20, the heater signal may be more affected by noise generated from the communication signal transmitted by the communication line 220 than the first power line 211.

The multi-layer structure cable 200 according to the embodiment may be implemented in a structure where the second power line 212 is disposed on the innermost side of the multi-layer structure cable 200, thereby separating the second power line 212 from the communication line 220. Therefore, according to the multi-layer structure cable 200 according to the embodiment, the signal transmitted by the second power line 212 may be stably transmitted to the receiving end 20 with less influence of noise generated from the communication signal.

A plurality of second power lines 212 may be arranged along the circumferential direction of the multi-layer structure cable 200. For example, there may be 10 second power lines 212 arranged. The second power line 212 may be arranged in pairs in the circumferential direction of the multi-layer structure cable 200. For example, when there are 10 second power lines 212, 5 pairs of second power lines 212 may be arranged in the circumferential direction of the multi-layer structure cable 200.

In a modified embodiment, the second power line 212 may be disposed outside the first power line 211. That is, in a modified embodiment, the second power line 212 may be disposed between the communication line 220 and the first power line 211, and the first power line 211 may be disposed on the innermost side of the multi-layer structure cable 200.

The communication line 220 functions to transmit communication signals between the transmitting end 10 and the receiving end 20. The communication signal transmitted by the communication line 220 may be a control command signal for operating the inkjet head. The communication line 220 may be located outside the power line 210.

A plurality of communication lines 220 may be arranged in the circumferential direction of the multi-layer structure cable 200. For example, 36 communication lines 220 may be arranged. The communication lines 220 may be arranged in pairs in the circumferential direction of the multi-layer structure cable 200. For example, when there are 36 communication lines 220, 18 pairs of communication lines 220 may be arranged in the circumferential direction of the multi-layer structure cable 200.

The first shield 230 may be disposed between the communication line 220 and the power line 210. The first shield 230 may function to shield signal interference between signal interference between the communication line 220 and the power line 210 by shielding the electromagnetic field caused by the power line 210 and the electromagnetic field caused by the communication line 220. Accordingly, the lines 210 and 220 may stably transmit each signal to the receiving end 20.

In addition, the first shield 230 may reduce the return loss of a communication signal by lowering the characteristic impedance of the multi-layer structure cable 200 according to the embodiment. Accordingly, the multi-layer structure cable 200 according to the embodiment may be impedance matched with the receiving end 20.

The first shield 230 may be arranged in the circumferential direction of the communication line 220. The first shield 230 may extend in one direction along with the communication line 220 and the power line 210. The first shield 230 may include a metal material.

The distance between the first shield 230 and the communication line 220 (L3, shown in FIG. 13) may be shorter than the distance between the first shield 230 and the power line 210 (L4, shown in FIG. 13). Here, the power line 210 may be the first power line 211. Accordingly, the communication line 220 may be placed closer to the first shield 230 than the first power line 211. As the communication line 220 is placed closer to the first shield 230, the impedance of the multi-layer structure cable 200 according to the embodiment may be lowered. Accordingly, the communication line 220 may have a uniform impedance in the direction in which the first shield 230 extends, and thus the communication signal may be stably transmitted to the receiving end 20.

The second shield 240 is disposed outside the communication line 220. The second shield 240 may function to shield signals of the communication line 220 from being transmitted to the outside. That is, the second shield 240 may reduce the possibility of external electronic devices being affected by noise caused by communication signals by shielding the electromagnetic field caused by the communication line 220.

In addition, the second shield 240 may lower the characteristic impedance of the multi-layer structure cable 200 according to the embodiment, thereby lowering the return loss of the communication signal. Accordingly, the multi-layer structure cable 200 according to the embodiment may be impedance matched with the receiving end 20.

The second shield 240 may be arranged in the circumferential direction of the communication line 220. The second shield 240 may extend in one direction along with the communication line 220 and the power line 210. The second shield 240 may include a metal material.

The third shield 250 is disposed outside the second shield 240. The third shield 250, together with the second shield 240, may perform the function of shielding the signal of the communication line 220 from being transmitted to the outside. That is, the third shield 250 and the second shield 240 double shield the electromagnetic field caused by the communication line 220, thereby further reducing the possibility that external electronic devices will be affected by noise caused by communication signals.

In addition, the third shield 250 may reduce the return loss of communication signals by lowering the characteristic impedance of the multi-layer structure cable 200 according to the embodiment. Accordingly, the multi-layer structure cable 200 according to the embodiment may be impedance matched with the receiving end 20.

The third shield 250 may be arranged along the circumferential direction of the communication line 220. The third shield 250 may extend in one direction along with the communication line 220 and the power line 210. The third shield 250 may include a metal material.

The inter-power shield 260 may be disposed between the first power line 211 and the second power line 212. The inter-power shield 260 may perform a function of shielding signal interference between the first power line 211 and the second power line 212. That is, the inter-power shield 260 may block signal interference between the first power line 211 and the second power line 212 by shielding the electromagnetic field caused by the first power line 211 and the electromagnetic field caused by the second power line 212. Accordingly, the power lines 211 and 212 may stably transmit each signal to the receiving end 20.

In addition, the inter-power shield 260 may reduce the return loss of communication signals by lowering the characteristic impedance of the multi-layer structure cable 200 according to the embodiment. Accordingly, the multi-layer structure cable 200 according to the embodiment may be impedance matched with the receiving end 20.

The inter-power shield 260 may be arranged in the circumferential direction of the power line 210. The inter-power shield 260 may extend in one direction along with the power line 210. The inter-power shield 260 may include a metal material.

By using the inter-power shield 260 and the first shield 230, the multi-layer structure cable 200 may be implemented as a structure having three layers. That is, as shown in FIG. 14, the multi-layer structured cable 200 according to the embodiment includes a first layer Layer 1 including a second power line 212 disposed inside the inter-power shield 260, a second layer Layer 2 including a inter-power shield 260 and a first power line 211 disposed between the first shields 230, and a third layer Layer 3 including a communication line 220 disposed outside the first shield 230.

The external insulator 270 may be disposed outside the third shield 250. The external insulator 270 may extend in one direction together with the third shield 250. The external insulator 270 may include an insulating rubber material.

The cable pillar 280 is disposed inside the second power line 212. The cable pillar 280 may extend in one direction along with the power line 210. The cable filler 280 may include polyvinyl chloride, non-halogen-based retardant thermoplastic resin, or polyethylene material.

The multi-faceted signal amplification repeater, a multi-layer structure cable, and a communication system including the repeater and the cable according to the technical idea of the present invention can overcome signal attenuation in long-distance communication and reduce the possibility of communication errors to ensure stable communication.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A multi-faceted signal amplification repeater comprising:
N (N is an integer of 3 or more) repeater modules surrounding a cable for signal transmission between a transmitting end and a receiving end; and
N connect pins connecting the N repeater modules to each other,
wherein among the N repeater modules, M (M is an integer greater than or equal to 1 but less than N) repeater modules are repeater units that amplify a signal transmitted through the cable, and
among the N repeater modules, L (L is an integer equal to N−M) power units are power units that supply power for an operation of the repeater units.

2. The multi-faceted signal amplification repeater of claim 1, further comprising a connector connecting at least one of the M repeater units and a communication line disposed in the cable to each other.

3. The multi-faceted signal amplification repeater of claim 1, wherein a power line disposed within the cable passes through the N repeater modules without being connected to the connector.

4. The multi-faceted signal amplification repeater of claim 1, wherein the power unit supplies power to the repeater unit using power used in the transmitting end or the receiving end.

5. The multi-faceted signal amplification repeater of claim 4, wherein the power unit supplies power to the repeater unit through the connect pin.

6. The multi-faceted signal amplification repeater of claim 1, wherein at least one of the N repeater modules includes a terminating resistance having a resistance matched to the impedance of the cable.

7. The multi-faceted signal amplification repeater of claim 1, wherein an insertion hole is formed by the N repeater modules arranged to surround the cable, and the cable is inserted into the insertion hole.

8. The multi-faceted signal amplification repeater of claim 1, wherein a size of the repeater unit is greater than a size of the power unit.

9. The multi-faceted signal amplification repeater of claim 1, wherein M is greater than or equal to L.

10. The multi-faceted signal amplification repeater of claim 1,
wherein when N is 4 or more and M is 2 or more,
one of the M repeater units is arranged to face another one of the M repeater units.

11. The multi-faceted signal amplification repeater of claim 1,
wherein when N is 3 or more and L is 1 or more,
L power units are arranged so that the repeater units are located on both sides of the L power units.

12. The multi-faceted signal amplification repeater of claim 1, wherein a distance between the repeater unit and the cable is less than a distance between the power unit and the cable.

13. A multi-layer structure cable comprising:
a power line transmitting power signals between a transmitting end and a receiving end;
a communication line disposed outside the power line and transmitting a communication signal between the transmitting end and the receiving end; and
a first shield disposed between the communication line and the power line to shield signals against interference between the power line and the communication line and for impedance matching with the receiving end.

14. The multi-layer structure cable of claim 13,
wherein the power line includes a first power line that transmits a direct current (DC) signal and a second power line that is disposed inside the first power line and transmits an alternating current (AC) signal.

15. The multi-layer structure cable of claim 14, further comprising
an inter-power shield disposed between the first power line and the second power line to shield signals against interference between the first power line and the second power line.

16. The multi-layer structure cable of claim 13, wherein a distance between the first shield and the communication line is less than a distance between the first shield and the power line.

17. The multi-layer structure cable of claim 13, further comprising a second shield disposed outside the communication line.

18. A communication system comprising:
a multi-layer structure cable including a power line that transmits a power signal between a transmitting end and a receiving end, a communication line disposed outside the power line and transmitting a communication signal between the transmitting end and the receiving end, and a first shield disposed between the communication line and the power line to shield signals against interference between the power line and the communication line and for impedance matching with the receiving end; and
a multi-faceted signal amplification repeater having N repeater modules surrounding the multi-layer structure cable (N is an integer of 3 or more) and N connect pins connecting the N repeater modules to each other.

19. The communication system of claim 18,
wherein among the N repeater modules, M (M is an integer greater than or equal to 1 but less than N) repeater units are repeater units that amplify a signal transmitted through the cable, and
among the N repeater modules, L (L is an integer equal to N−M) power units are power units that supply power for an operation of the repeater units.

20. The communication system of claim 19,
wherein the multi-faceted signal amplification repeater further includes a connector connecting at least one of the M repeater units to a communication line disposed within the multi-layer structure cable.
